(19) United States
(12) Patent Application Publication
(10) Pub. No.: US 2006/0267232 A1
(43) Pub. Date: Nov. 30, 2006

(54) Process control system and a mold assembly for expandable plastic containers

(76) Inventors: Michael T. Williams, Beaver Falls, PA (US); Dennis H. Piispanen, Beaver, PA (US)

Correspondence Address: Suzanne Kikel;NOVA Chemicals Inc., 400 Frankfort Rd., Monaca, PA, 15061, US

(21) Appl. No.: 11/138,663

(22) Filed: May 26, 2005

(51) Int. Cl. B29C 44/60

(52) U.S. Cl. 264/40.6; 264/51; 425/4 R; 425/144

(57) ABSTRACT

A mold assembly for forming a container made of expandable thermoplastic particles, e.g. expandable polystyrene particles, comprises an inner mold and an outer mold, which when assembled form a mold cavity for receiving the thermoplastic particles. Steam and cooling fluid are supplied to passageways in the inner mold and outer mold. Temperature sensing devices, e.g. thermocouples, permanently mounted to the inside wall of the inner mold and to the outside wall of the outer mold, detect the temperature of the mold assembly. Pressure transducers in communication with the steam and cooling fluid being supplied into the passageways detect the pressure of the steam and water supplied to the passageways. These devices are continuously operative throughout the supply of steam and cooling fluid in the molding cycle to adjust the pressure and/or cycle time of the steam and to adjust the cycle time of the cooling fluid to optimally fuse together and cool the particles in the mold assembly.

### BACKGROUND OF THE INVENTION

1. Field of the Invention

The present invention relates to a mold assembly for containers molded from expandable plastic materials, for example, expandable polystyrene particles. More particularly, the invention relates to a mold assembly design modification and a process control system for continuously detecting and using real data acquisition information representing the processing parameters of a mold assembly and adjusting these parameters to optimize the fusion and cooling of the particles in a molding cycle.

2. Background Art

Expanded or foam plastic containers, e.g. cups, bowls, etc. are conventionally formed by injecting particles of a suitable thermoplastics material into a mold cavity which defines the desired shape of the container and delivering steam into the mold cavity to fuse the particles together to form the container, and thereafter, delivering cooling fluid into the mold cavity to cool the particles in a molding cycle. The particles are expandable in that they are impregnated with a foaming or blowing agent that allows the particles to be expanded when subjected to steam or heat.

The most commonly used thermoplastic particles are expandable polystyrene particles known as EPS. The foaming or blowing agent boils below the softening point of the polystyrene and causes the particles to expand when they are heated.

The formation of molded containers from impregnated polystyrene particles is generally done in two steps. First, the impregnated polystyrene particles are pre-expanded to a density of from about 2 to 12 pounds per cubic foot. Second, the pre-expanded particles are generally heated in the closed mold cavity to further expand the pre-expanded particles to fuse the particles together to form the foam container.

The expandable polystyrene particles used to make foam containers are generally prepared by an aqueous suspension polymerization process, which results in beads that can be screened to relatively precise bead sizes. Typically, bead diameters are within the range of from about 0.008 to about 0.02 inch. Occasionally, cups are made from particles having bead diameters as high as 0.03 inches.

In spite of careful bead size control, a problem that continues to plague the container industry is that after a period of time the EPS containers have a tendency to leak. That is, the liquid tends to seep out around the fused polystyrene beads and onto the outer surface of the sidewall of the container.

Several approaches have evolved over the years directed toward the reduction of leakage in these containers. Some approaches have involved the use of polypropylene film liners laminated to the foam material, such as that disclosed in U.S. Pat. No. 4,036,675.

Other approaches have involved the treatment of the bead surfaces. For example, Sonnenberg U.S. Pat. Nos. 4,703,065 and 4,720,419 disclose thermoplastic polymer foam cups molded from polymer particles and having surfaces coated with a fluoro-surfactant before molding, and U.S. Pat. No. 4,785,022 discloses coating the particles with various rubber polymers and copolymers.

A further approach involves the mold assembly used to form the container. The mold assembly has heating and cooling passageways that provide a pathway for steam, water, or air to pass through to accomplish specific steps in the process of molding a container. It has been known to troubleshoot the mold processing of a container by attaching a data acquisition device, e.g. thermocouple onto the outside wall of the mold assembly on a temporary basis and make necessary adjustments to the mold processing parameters. This temporary method of acquiring data acquisition may be acceptable in some situations however it does not provide a means and method for ensuring that the mold processing parameters are maintained in the recommended ranges to optimize the fusing and cooling effects of the particles in the mold assembly.

That is, this practice does not provide for obtaining critical information on a continuous long-term basis, and which information can then be used to continuously and automatically make appropriate adjustments to the mold processing parameters, i.e. at least the pressure and/or cycle time of the steam and/or the cycle time of the cooling fluid in the mold assembly in order to maintain the recommended ranges of these parameters to thereby obtain a successful molding cycle whereby the expandable particles are optimally fused together and then cooled to form a container with improved liquid retentive properties.

### SUMMARY OF THE INVENTION

The present invention provides a design modification to a mold assembly and a process control system for optimally fusing and cooling the thermoplastic particles in a molding cycle.

The invention relates to a mold assembly for molding a container from expandable plastic particles, the container having a bottom wall, and a sidewall extending upwardly from the bottom wall to a mouth of the container, the mold assembly comprising:

an inner mold and an outer mold assembled together to form a mold cavity defining the container;

port means in communication with the outer mold for delivering expandable plastic particles into the mold cavity,

passageway means for carrying steam and cooling fluid into the inner mold and the outer mold adjacent the mold cavity and extending adjacent that portion of the mold cavity defining the bottom wall and sidewalls of the container;

conduit means for delivering steam and cooling fluid into said passageway means;

temperature sensing means permanently affixed to an inner wall of the inner mold and to an outer wall of the outer mold for sensing the temperature of the mold assembly;

pressure transducer means in association with said conduit means for sensing at least the steam pressure in the conduit means; and

control means in communication with the temperature sensing means and the pressure transducer means for continuously monitoring the temperature of the mold assembly and the pressure of the steam in the conduit means and adjusting at least the pressure and/or cycle time of the steam in the mold assembly to optimally fuse the expandable plastic particles, and for continuously monitoring the temperature of the mold assembly and the pressure of the cooling fluid in the conduit means and adjusting at least the cycle time of the cooling fluid to optimally cool the expandable plastic particles in the mold assembly for the forming of a container.

Preferably, the temperature sensing means is comprised of thermocouples, one located inside the mold assembly and one located outside the mold assembly. These sensing devices are permanently mounted to the inner mold and outer mold, in particular, one thermal device is permanently mounted to the inside wall of the inner mold and one thermal device is permanently mounted to the outside wall of the outer mold. In some embodiments, the temperature sensing devices may be located in direct alignment with each other to detect and measure the temperature of the walls of the mold assembly, and in some embodiments, these devices may not be located in direct alignment with each other.

The pressure transducer means are in communication with the conduits that deliver the steam and cooling fluid into the passageways of the mold assembly for the molding cycle. For the mold heating cycle, both the mold temperature and the steam pressure are continuously sensed and this information is automatically fed to an integrated data acquisition means, which may be a computer system. The pressure transducer means sends the pressure value of the steam to the integrated data acquisition instrument, and this information along with the temperature values of the mold assembly which are sensed by the temperature sensing devices is used to adjust the steam pressure or the steam cycle time and therefore the temperature of the steam within an acceptable range for optimally fusing the expandable particles in the mold assembly.

For the mold cooling cycle, the mold temperature and the pressure of the cooling fluid are continuously sensed and this information is automatically fed to an integrated data acquisition means. The pressure transducer means sends the pressure value of the cooling fluid to the integrated data acquisition instrument, and this information along with the temperature values of the mold assembly which are sensed by the temperature sensing devices is used to adjust at least the cycle time of the cooling fluid for optimally cooling the expandable particles in the mold assembly.

The invention further relates to a process for continuously monitoring the pressure of the steam or cooling fluid delivered through the conduit means into the passageways of a mold assembly for forming a container made of expandable plastic particles, the steps comprising:

providing permanently mounted temperature sensing means on the mold assembly for sensing the temperature of the mold assembly,

providing pressure transducer means for sensing the pressure of the steam or cooling fluid and in communication with the conduit means that delivers the steam or cooling fluid into heating/cooling passageways of the mold assembly, and

continuously monitoring the temperature of the mold assembly and the pressure of the steam and adjusting at least the pressure and/or cycle time of the steam in the mold assembly to optimally fuse the expandable plastic particles, and for continuously monitoring the temperature of the mold assembly and the pressure of the cooling fluid and adjusting at least the cycle time of the cooling fluid to optimally cool the expandable plastic particles in the mold assembly in the forming of the container.

The invention further relates to a process control system for a mold assembly for molding a container from expandable plastic beads, the container having a bottom wall, and a sidewall extending upwardly from the bottom wall to a mouth of the container, the process control system comprising:

a mold assembly having an inner mold and an outer mold which are assembled to form a mold cavity defining the container;

port means in communication with the outer mold for delivering expandable plastic beads into the mold cavity,

passageway means for delivering steam and cooling fluid in the inner mold and outer mold adjacent the mold cavity and extending adjacent that part of the cavity defining the sidewall and the bottom wall of the container;

conduit means for delivering steam and cooling fluid into said passageway means;

temperature sensing means permanently affixed to the inner mold and outer mold for sensing the temperature of the mold assembly;

pressure transducer means in association with said conduit means for sensing at least the pressure of the steam in the conduit means; and

control means in communication with the temperature sensing means and the pressure transducer means for continuously monitoring the temperature of the mold assembly and the pressure of the steam in the conduit means and adjusting at least the pressure and/or cycle time of the steam to optimally fuse the expandable plastic beads, and for continuously monitoring the temperature of the mold assembly and the pressure of the cooling fluid in the conduit means and adjusting at least the cycle time of the cooling fluid to optimally cool the expandable plastic particles in the mold assembly in the forming of a container.

A further embodiment of the invention relates to a process for optimally fusing and cooling expandable plastic beads to form a container by using the process control and the mold assembly of the invention.

In some embodiments, the invention provides a mold assembly and a process control system that continuously detects the pressure and temperature of the steam being delivered into the passageways of the inner mold and outer mold for an optimal fusion of the particles.

These and other aspects of the present invention will be better appreciated and understood by those skilled in the art from the drawings, and the following description and appended claims.

### BRIEF DESCRIPTION OF THE DRAWING

FIG. 1 is a half sectional, half elevational view of an expanded plastic cup produced by the invention.

FIG. 2 is an axial sectional view that illustrates a mold assembly and the devices used in the invention.

FIG. 2a is an exploded view illustrating the temperature sensing devices in the mold assembly.

### DETAILED DESCRIPTION OF THE INVENTION

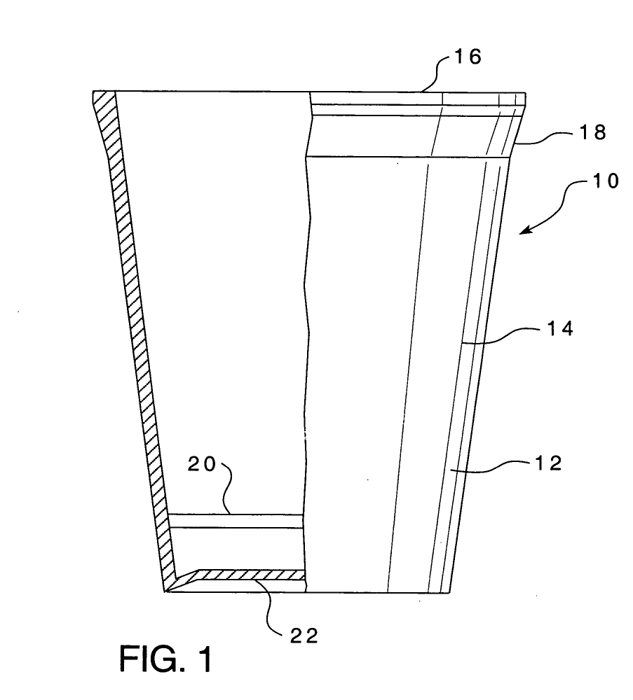

Referring to FIG. 1, an expanded or foam plastic cup 10 is molded from expanded polystyrene particles, and in view of the invention, is a product of foam plastics material and is of high integrity in that the particles are optimally fused and cooled for a cohesive, continuous surface whereby the interstices between the particles are essentially eliminated.

Cup 10 is of circular shape and comprises a bottom wall 12, a sidewall 14 extending upwardly and outwardly from the bottom wall to a mouth 16 at the top of the cup where the sidewall 14 terminates in an annular flat flange 18. In a conventional manner, cup 10 is molded internally adjacent its bottom wall with an annular flat internal stacking shoulder 20. When several cups are in a nesting relationship, the stacking shoulder 20 of a lower cup engages with the periphery of the bottom 22 of an upper cup so as to resist compression of the inner cup with the outer cup.

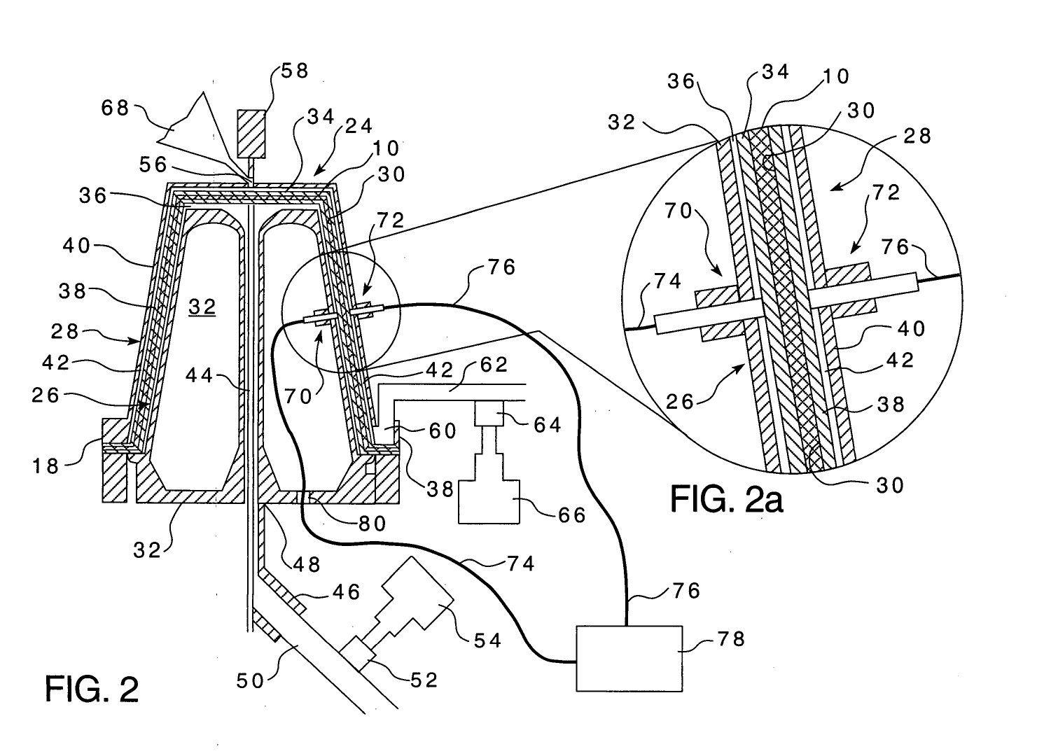

Referring to FIG. 2, and in one conventional manner, mold assembly 24 is used to mold cup 10 with its bottom 22 uppermost and its mouth 16 directed downwardly. Those skilled in the art are familiar with mold assembly 24 and its operation for producing a cup, which generally is similar to that taught in U.S. patent application No. 2003/0146533 published on Aug. 7, 2003, the reference of which is incorporated herein in its entirety.

Referring particularly to FIG. 2a, mold assembly 24 is comprised of an inner mold 26 and an outer mold 28 which are assembled to form a mold cavity 30, which, in turn, receives expandable polystyrene particles to form cup 10. The inner mold 26 has a core section 32 and an outer shell 34 fitted over the core section 32 so as to form a heating/cooling passageway 36 between the outer shell 34 and the core section 32. The outer mold 28 comprises an inner shell 38 which molds the external surfaces of the bottom and sidewall of the cup and a top mold member 40 which is fitted over the outside of the inner shell 38 so as to provide a heating/cooling passageway 42 between the inner shell 38 and the top mold member 40 of outer mold 28. As shown in FIG. 2, at the bottom end of the mold cavity 30, the outer shell 34 of the inner mold 26 and the inner shell 38 of the outer mold 28 define the annular flat flange 18 of cup 10.

The core section 32 and outer shell 34 of inner mold 26 are secured together at the bottom end of mold assembly 24 by means not shown in FIG. 2 but known to those skilled in the art. The inner shell 38 and top mold member 40 of outer mold 28 are secured together at the bottom end of mold assembly 24 by means not shown in FIG. 2 but known to those skilled in the art.

In FIG. 2, a central conduit 44 extends centrally through inner core section 32 to a position adjacent the upper end thereof and supplies to passageway 36 either steam for heating the mold assembly 24 during the fusion cycle for melting the particles in forming the container or a cooling fluid, e.g. water for cooling the mold assembly 24, and therefore, the container, at the end of the fusion cycle.

Steam or cooling fluid is delivered to central conduit 44 by a conduit 50. Conduit 50 is in communication with central conduit 44 via sleeve 46, which is attached to inner core section 32 as shown at 48 in FIG. 2. Conduit 50 contains a juncture conduit 52 which connects a pressure transducer 54 in communication with conduit 50, which as stated, directs steam or cooling fluid into central conduit 44.

Central conduit 44 is connected at its upper end via a valve port 56 in communication with a pneumatic actuating mechanism 58, which in a known manner permits compressed air to be supplied into mold cavity 30 so as to assist in ejecting a molded cup 10 from mold cavity 30 at the end of the molding cycle.

Steam and cooling fluid are also supplied to the outer heating/cooling passageway 42 via port 60 and conduit 62, which carries the steam or cooling fluid into passageway 42. Conduit 62 contains a juncture conduit 64, which connects a pressure transducer 66 to conduit 62 and therefore is in communication with the steam or cooling fluid supplied into passageway 42.

Particles of a suitable molding material for cup 10, and comprising a blowing agent, are supplied to mold cavity 30 through port 68 shown at the upper left hand portion of FIG. 2.

In a known manner, compressed air is delivered into port 56 via pneumatic actuating means 58 to force the particles or beads from port 68 into port 56 and down into mold cavity 30. Compressed air is delivered into port 56 via pneumatic actuating means 58 when inner mold 26 and outer mold 28 of mold assembly 24 are separated at the end of a molding cycle in order to retain cup 10 on the inner mold 26 preparatory to its ejection from mold assembly 24.

As clearly seen in FIG. 2a, core section 32 of inner mold 26 is hollowed out for the mounting of a temperature-sensing device 70 to the inside wall of core section 32 of inner mold 26. A second temperature-sensing device 72 is mounted to the outer wall of top mold member 40 of outer mold 28 directly in alignment with temperature-sensing device 70 in core section 32. Devices 70 and 72 are permanently mounted and remain affixed to the inside wall of core section 32 of inner mold 26 and to the outer wall of top mold member 40 of outer mold 28, respectively, throughout the molding cycle.

These temperature-sensing devices 70 and 72 are used to detect the temperature of the mold assembly 24. Preferably, these devices 70 and 72 are thermocouples, and as shown in FIG. 2 have an electrical wire 74 and 76, respectively, which are connected to a data acquisition instrument 78 shown schematically in the right hand bottom of FIG. 2. Electrical wire 74 extends out of core section 32 via port 80 mounted in the bottom portion of inner mold 26.

As stated herein above, pressure transducer 54 senses the pressure of the steam and cooling fluid in conduit 50, and pressure transducer 66 senses the pressure of the steam and cooling fluid in conduit 62. This pressure information is continuously sent to the data acquisition instrument 78, along with the mold temperature information detected by temperature sensing devices 70 and 72. The data acquisition instrument 78 uses the information received from temperature sensing devices 70 and 72 and from pressure transducers 54 and 66 (for the heating portion of the molding cycle) to adjust the pressure and/or cycle time of the steam and (for the cooling portion of the molding cycle) to adjust the cycle time of the cooling fluid traveling through conduits 50 and 62 and into passageways 36 and 42 in inner mold 26 and outer mold 28, respectively. The pressure and/or cycle time of the steam will be within a desired range to provide enough heat to optimally fuse the expandable particles together to form cup 10, and the cycle time of the cooling fluid will be within a desired range to optimally cool the expandable particles. The steam temperature in view of the steam pressure may range from about 100° F. to about 300° F., and preferably, from about 160° F. to about 260° F.

In order to mold an expanded plastic cup 10, the inner mold 26 and outer mold 28 are assembled as illustrated in FIG. 2, and plastics molding beads or particles are injected into the mold cavity 30 via the funnel shaped port 68 in outer mold 28. When the mold cavity 30 is filled with the particles, steam is injected through the conduit 50 and supplied to inner passageway 36, and steam is injected through conduit 62 and supplied to outer passageway 42 to heat the walls of the passageways 36, 42, and therefore, the particles in mold cavity 30.

Throughout the molding cycle, and as the steam is traveling through passageways 36 and 42, the temperature-sensing devices 70 and 72 continuously operate to detect the temperature of the walls of the mold assembly 24 and to send this information in the form of signals through electrical wires 74 and 76 to data acquisition instrument 78.

Simultaneously, pressure transducer devices 54 and 66 detect the steam pressure in conduits 50 and 62, and send this information in the form of signals to data acquisition instrument 78. The temperature of the steam pressure is determined through standard steam tables. The steam temperature is compared to a desired temperature for the steam traveling into conduit 50 and 62, and therefore, into passageways 36 and 42. If the temperature of the steam is to be adjusted for optimal fusion of the particles in mold cavity 30, then data acquisition instrument 78 sends a signal to a control (not shown) to adjust the steam pressure accordingly, or in some instances, to adjust the cycle time of the steam being supplied to the mold assembly.

At the end of the heating cycle of the molding cycle, the valve members for the steam supply (not shown) are closed and cooling fluid is supplied, via conduits 50 and 62 into the heating/cooling passageways 36 and 42 in order to cool the mold assembly 24 and the molded cup 10. In this procedure, temperature sensing devices 70 and 72 and pressure transducers 54 and 66 operate to detect the temperature of mold assembly 24, and these signals are sent to data acquisition instrument 78. If the cooling fluid is to be adjusted for optimal cooling of the particles in mold cavity 30, then data acquisition instrument 78 sends an appropriate signal to a control (not shown) to adjust the cycle time of the cooling fluid being supplied to the mold assembly.

Data acquisition instrument 78 may comprise a computer system that is capable of interfacing thermocouples and transducer signals to data control and collection programs.

Even though thermocouples and pressure transducers have been disclosed it is to be understood that other temperature-sensing devices and pressure sensing devices may be used. Also, other recording data and feedback systems, such as programmable logic controllers (PLC's) may be used instead of a computer program.

While particular embodiments have been described, it will be understood that modifications Can be made to the invention without departing from the scope of the invention as defined by the appended claims.

What is claimed is:

1. A mold assembly for molding a container from expandable plastic particles in a molding cycle, the container having a bottom wall, and a sidewall extending upwardly from the bottom wall to a mouth of the container, the mold assembly comprising:
an inner mold and an outer mold assembled together to form a mold cavity defining the container;
port means in communication with the outer mold for delivering expandable plastic particles into the mold cavity,
passageway means for carrying steam and cooling fluid into the inner mold and the outer mold adjacent the mold cavity and extending adjacent that part of the mold cavity defining the bottom wall and sidewalls of the container;
conduit means for delivering steam and cooling fluid into said passageway means;
temperature sensing means mounted to an inner wall of said inner mold and to an outer wall of said outer mold for sensing the temperature of the mold assembly;
pressure transducer means in association with said conduit means for sensing the pressure of the steam and the cooling fluid in said conduit means; and
control means in communication with the temperature sensing means and the pressure transducer means for continuously monitoring the temperature of the mold assembly and the pressure of the steam in said conduit means and adjusting at least the pressure and/or cycle time of the steam to optimally fuse the expandable plastic particles, and for continuously monitoring the temperature of the mold assembly and the pressure of the cooling fluid in said conduit means and adjusting at least the cycle time of the cooling fluid to optimally cool the expandable plastic particles in the mold assembly during the molding cycle for the forming of a container.

2. A mold assembly of claim 1 wherein said temperature sensing means are permanently mounted to the inner mold and the outer mold of said mold assembly.

3. A mold assembly of claim 2 wherein said temperature sensing means is comprised of thermocouples permanently mounted to said inner mold and to said outer mold of said mold assembly.

4. A mold assembly of claim 1 further comprising juncture conduit means connected to said conduit means for delivering the steam and cooling fluid into said passageways in the mold assembly, and wherein said pressure transducer means is attached to and in communication with said juncture conduit means.

5. A mold assembly of claim 1 wherein said control means comprises integrated data acquisition means including means for adjusting the pressure and/or cycle time of the steam in the passageways in the mold assembly to optimally fuse and cool the expandable plastic beads.

6. A process for continuously monitoring the pressure of the steam or cooling fluid delivered through conduit means into passageways of a mold assembly for forming a container made of expandable plastic particles, the steps comprising:
providing permanently mounted temperature sensing means on the mold assembly for sensing the temperature of the mold assembly,
providing pressure transducer means for sensing the pressure of the steam or cooling fluid and in communication with said conduit means that delivers the steam or cooling fluid into said passageways of the mold assembly, and
continuously monitoring the temperature of the mold assembly and the pressure of the steam and adjusting at least the pressure and/or cycle time of the steam in the molding assembly to optimally fuse the expandable plastic particles, and for continuously monitoring the temperature of the mold assembly and the pressure of the cooling fluid and adjusting at least the cycle time of the cooling fluid to optimally cool the expandable plastic particles in the mold assembly in the forming of the container.

7. A process for optimally fusing expandable plastic beads in a mold assembly to form a container by using the process of claim 6.

8. A process for optimally cooling expandable plastic beads in a mold assembly to form a container by using the process of claim 6.

9. A control system for a mold assembly for molding a container from expandable plastic particles, the container having a bottom wall, and a sidewall extending upwardly from the bottom wall to a mouth of the container, the process control system comprising:
a mold assembly having an inner mold and an outer mold which are assembled to form a mold cavity defining the container;
port means in communication with the outer mold for delivering expandable plastic beads into the mold cavity,
passageway means for delivering steam and cooling fluid in at least one the inner mold or outer mold adjacent the mold cavity and extending adjacent that part of the cavity defining the sidewall and the bottom wall of the container;
conduit means for delivering steam and cooling fluid into said passageway means;
temperature sensing means permanently affixed to the inner mold and the outer mold for sensing the temperature of the mold assembly;
pressure transducer means in association with said conduit means for sensing the pressure of the steam and cooling fluid in the conduit means; and
control means in communication with said temperature sensing means and said pressure transducer means for continuously monitoring the temperature of the mold assembly and the pressure of the steam in the conduit means and adjusting at least the pressure and/or cycle time of the steam to optimally fuse the expandable plastic beads, and for continuously monitoring the temperature of the mold assembly and the pressure of the cooling fluid in the conduit means and adjusting at least the cycle time of the cooling fluid to optimally cool the expandable plastic particles in the mold assembly in the forming of said container.

10. A control system of claim 9 wherein said control means comprises integrated data acquisition means including means for adjusting the pressure and/or cycle time of the steam in the passageways in the mold assembly to optimally fuse and cool the expandable plastic beads.

11. A control system of claim 9 wherein said temperature sensing means are permanently mounted to the inner mold and outer mold of the mold assembly.

12. A control system of claim 9 wherein said temperature sensing means is comprised of thermocouples permanently mounted to said inner mold and to said outer mold of said mold assembly.

13. A control system of claim 9 further comprising juncture conduit means connected to said conduit means for delivering the steam and cooling fluid into said passageways in the mold assembly, and wherein said pressure transducer means is attached to and in communication with said juncture conduit means.
